(19) United States
(12) Patent Application Publication
(10) Pub. No.: US 2022/0009209 A1
(43) Pub. Date: Jan. 13, 2022

(54) Bendable Device

(71) Applicant: SHENZHEN ROYOLE TECHNOLOGIES CO., LTD., Shenzhen (CN)

(72) Inventors: Xiaofei XUE, Shenzhen (CN); Songya CHEN, Shenzhen (CN)

(21) Appl. No.: 17/369,081

(22) Filed: Jul. 7, 2021

(30) Foreign Application Priority Data
Jul. 8, 2020 (CN) 202010650582.3

(51) Int. Cl. B32B 27/08; B32B 7/12; B32B 3/20; B32B 3/30

(52) U.S. Cl. CPC B32B 27/08; B32B 7/12; B32B 2307/546; B32B 3/30; B32B 2307/51; B32B 3/20

(57) ABSTRACT

The present disclosure discloses a bendable device. The bendable device comprises a screen layer, a supporting layer and a bending layer, wherein the bending layer comprises a first main body, a second main body and a bendable component. The first main body is connected with the second main body through the bendable component, the bending layer, the supporting layer and a flexible layer are arranged in a laminated manner successively. In the present disclosure, the supporting layer comprises the hollow pieces, the hollow pieces comprising the at least one first branch with the vertical component, so that stacked material at a hollow portion of the hollow pieces has a small overall modulus, and stacked material of a non-hollow portion has a large overall modulus due to a large material modulus of the supporting layer. When bending the bendable device, the large stress could be released.

### TECHNICAL FIELD

The present disclosure relates to the technical field of electronic industry, and particularly to a bendable device.

### BACKGROUND ART

Referring to FIGS. 1 and 2, an existing bendable electronic device 1′ generally comprises a flexible screen 11′, a supporting layer 12′ and a bending layer 13′ which are arranged in a laminated manner successively. The supporting layer 12′ is a whole block, connected to the flexible screen 11′ and the bending layer 13′ through glue layers 14′, and plays a role in supporting and protecting the flexible screen 11′. The bending layer 13′ comprises a first main body 131′, a second main body 132′ and a bendable component 133′, and the first main body 131′ is connected with the second main body 132′ through the bending component 133′.

However, during bending the existing bendable electronic device, stress could not be released, causing the large local stress.

### SUMMARY OF THE INVENTION

To overcome the existing problem in the related art, the present disclosure mainly aims to provide a bendable device capable of releasing stress in a bending process, thus avoiding the local stress.

To achieve the purpose, the present disclosure specifically adopts the following technical solutions:

The present disclosure provides a bendable device, comprising:

a flexible layer;
a supporting layer; and
a bending layer, comprising a first main body, a second main body and a bendable component, wherein the first main body is connected with the second main body through the bending component;
the bending layer, the supporting layer and the flexible layer are arranged in a laminated manner successively, the supporting layer comprises a hollow pieces corresponding to the bendable component, and the hollow pieces comprises at least one first branch with a vertical component.

Preferably, the hollow pieces further comprises at least one second branch with a horizontal component.

Preferably, the bendable device further comprises a first buffer layer arranged between the hollow pieces and the flexible layer.

Preferably, a first groove is formed at one side of the hollow pieces close to the flexible layer, and filled by the first buffer layer.

Preferably, the bendable device further comprises a second buffer layer arranged between the hollow pieces and the bendable component.

Preferably, a second groove is formed at one side of the hollow pieces close to the bendable component, and filled by the second buffer layer.

Preferably, the first branch comprises a strip.

Preferably, the hollow pieces is one or any combination of a labyrinth structure, a structure having a plurality of rectangles surrounding one by one, and a V-shaped structure.

Preferably, the first buffer layer is made of at least one of polyimide, polyethylene terephthalate, polyurethane, and glue materials.

Preferably, the second buffer layer is made of at least one of polyimide, polyethylene terephthalate, polyurethane, and glue materials.

Compared with the prior art, the bendable device of the present disclosure comprises a bending layer, a supporting layer and a flexible layer arranged in a laminated manner successively, wherein the supporting layer comprises a hollow pieces which is arranged by corresponding to the bendable component, and the hollow pieces comprises at least one first branch with the vertical component, so that stacked material at a hollow portion of the hollow pieces has a small overall modulus, and stacked material of a non-hollow portion has a large overall modulus due to a large material modulus of the supporting layer. When bending the bendable device, the large stress could be released, i.e., released to the first branch, thus avoiding the large local stress of the bendable device.

### BRIEF DESCRIPTION OF THE DRAWINGS

FIG. 1 is a structural schematic view of a bendable electronic device in the related art.

FIG. 2 is a sectional view of the bendable electronic device at A′-A′ in FIG. 1.

FIG. 3 is a structural schematic view of a bendable device provided by an embodiment of the present disclosure.

FIG. 4 is a sectional view of the bendable device at A′-A′ in FIG. 3.

FIG. 5 is a structural schematic view for a hollow pieces of a bendable device provided by an embodiment of the present disclosure.

FIG. 6 is a partial structural schematic view of a bendable device provided by an embodiment of the present disclosure.

FIG. 7 is a structural schematic view for a hollow pieces of a bendable device provided by a second embodiment of the present disclosure.

FIG. 8 is a structural schematic view for a hollow pieces of a bendable device provided by a third embodiment of the present disclosure.

FIG. 9 is a structural schematic view for a hollow pieces of a bendable device provided by a fourth embodiment of the present disclosure.

FIG. 10 is a structural schematic view for a hollow pieces of a bendable device provided by a fifth embodiment of the present disclosure.

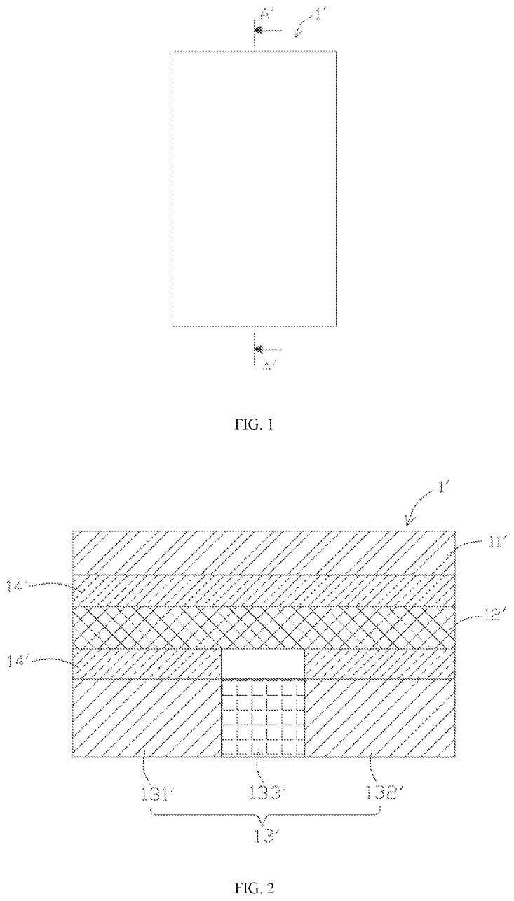

### REFERENCE NUMERALS OF DRAWINGS

1. bendable device; 11. flexible layer; 12. supporting layer; 121. hollow pieces; 121a. first branch; 121b. second branch; 121c. first groove; 121d. second groove; 13. light shield layer; 131. first light shield portion; 132. second light shield portion; 14. bending layer; 141. first main body; 142. second main body; 143. bendable component; 15. first buffer layer; 16. second buffer layer; 17. pressure-sensitive adhesive.

### DETAILED DESCRIPTION OF THE INVENTION

To make the purpose, the technical solution and the advantages of the present disclosure more clear, the present disclosure will be further described below in detail in combination with the drawings and the embodiment. It should be understood that the specific embodiments described herein are only used for explaining the present disclosure, not used for limiting the present disclosure.

Unless otherwise specifically regulated and defined, the terms such as “first” and “second” in the illustration of the present disclosure are only used for the purpose of description, rather than being understood to indicate or imply relative importance. Unless otherwise specified, the term “a plurality of” means two or more; terms such as “connecting”, “fixation” and the like shall be understood in broad sense, and for example, “connecting” may refer to fixed connection or detachable connection or integral connection, or electrical connection, and may refer to direct connection or indirect connection through an intermediate medium. For those ordinary skilled in the art, the specific meanings of the above terms in the present invention may be understood according to concrete conditions.

In the illustration of the description, it shall be understood that the “upper” and “lower” locations described in the embodiments of the present disclosure are described from the perspective shown in the attached drawings and shall not be construed as limiting the embodiments of the present disclosure. In addition, in this context, it shall be understood that when referring to a component connected on the “upper” or “lower” part of another component, it not only can be directly connected on the “upper” or “lower” part of another component, but also can be indirectly connected on the “upper” or “lower” part of another component through intermediate components.

A bendable electronic device with a screen meets customer demands, and thus becomes a mark of each electronic device manufacturer for pursuit of high end. Firstly, the bendable electronic device has a small size after bending, which meets hand feeling and facilitates the collection; and secondly, the bendable electronic device has a large usable area after unfolding, which meets the impressions.

However, in the related art, screens of some bendable electronic devices are not equipped with supporting layers at bending areas, so that the screens are not supported in the bending areas in a bending process. The screens are therefore in free state, stressed unevenly and unstably, and easily extruded with the stress. Or, some bendable electronic devices are equipped with the supporting layers of a whole block, making that the stress of the bendable electronic device in the bending process could not be released, thus causing large local stress.

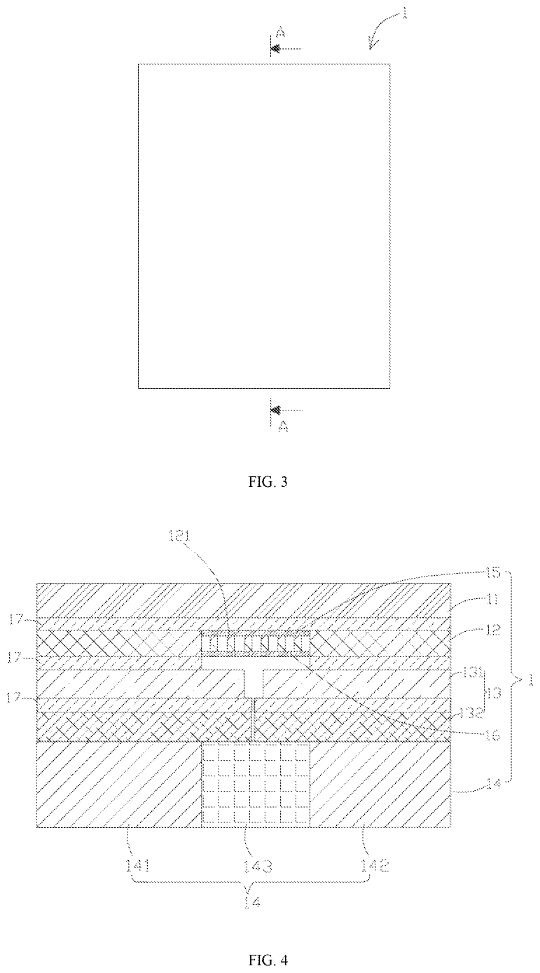

Referring to FIGS. 3 and 4, an embodiment of the present disclosure discloses a bendable device 1, comprising a flexible layer 11, a supporting layer 12, a light shield layer 13 and a bending layer 14. The flexible layer 11, the supporting layer 12, the light shield layer 13 and the bending layer 14 are arranged in a laminated manner successively along a thickness direction of the bendable device 1. Specifically, the bending layer 14 includes a first main body 141, a second main body 142 and a bendable component 143, wherein the first main body 141 is connected with the second main body 142 through the bendable component 143. The supporting layer 12 includes a hollow pieces 121 which is arranged by corresponding to the bendable component 143, and the hollow pieces 121 includes at least one first branch 121a with a vertical component, wherein the first branch 121a is hollow.

In the present disclosure, the supporting layer 12 includes the hollow pieces 121 corresponding to the bendable component 143, and the hollow pieces 121 includes the at least one first branch 121a with the vertical component, so that stacked material at a hollow portion of the hollow pieces 121 has a small overall modulus, and stacked material of a non-hollow portion has a large overall modulus. When bending the bendable device 1, the large stress could be released, i.e., released to the first branch 121a, thus avoiding the large local stress of the bendable device.

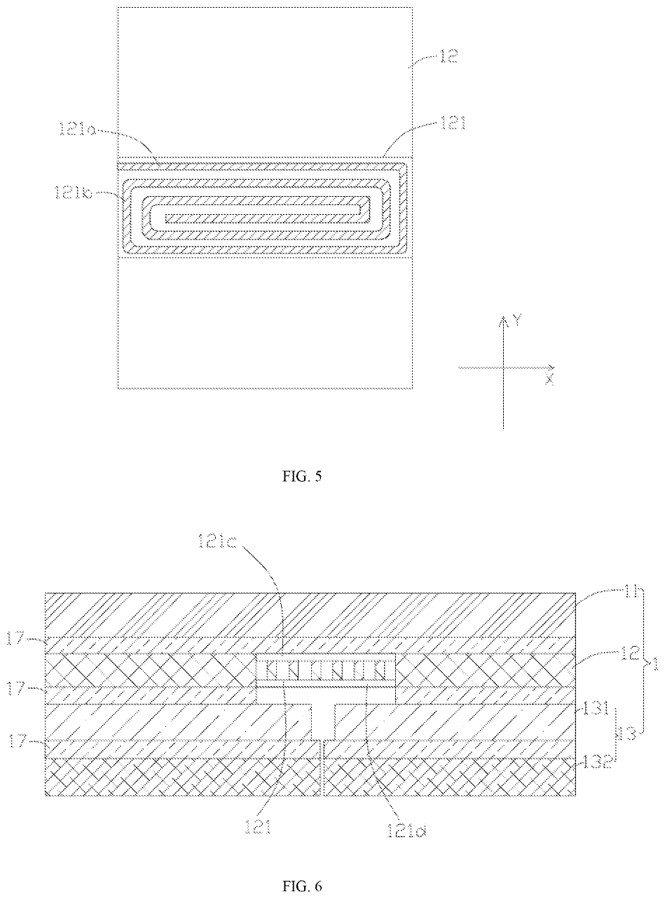

Referring to FIG. 5, in the present embodiment, the hollow pieces 121 further includes at least one second branch 121b with a horizontal component, wherein the second branch 121b is hollow and vertical to the first branch 121a. In the present disclosure, by providing the first branch 121a and the second branch 121b, the bendable device 1 is capable of release the large stress towards the first branch 121a along a Y direction or towards the second branch 121b along an X direction when bending, which further avoids the large local stress of the bendable device 1.

Further, when the bendable device is bent, the modulus transition at the hollow portion and the non-hollow portion in the hollow pieces 121 differs considerably. If the hollow pieces 121 only includes the first branch 121a with the vertical component, the bendable device 1 easily has a small R angle in the bending area when bending, the supporting layer 12 cannot well support the flexible layer 11, and a fatigue damage is easily caused to the flexible screen in the repeated bending process.

The hollow pieces 121 of the present disclosure includes the first branch 121a with the vertical component and the second branch 121b with the horizontal component, namely, two components are provided in mutual vertical directions, therefore, when the bendable device is bent, the module transition between the hollow portion and the non-hollow portion could be gentle, so as to avoid that the bendable device 1 generates the small R angle in the bending area when bending; and meanwhile, the supporting role for the flexible screen is strengthened, and a reverse bounce is provided in the repeated bending process, which could avoid the fatigue damage to the flexible screen.

In the present embodiment, the first branch 121a is strip and extends in the X direction, and the second branch 121b is also strip and extends in the Y direction. The first branch 121a is vertical to the second branch 121b to form a labyrinth structure. It could be understood that, in other embodiments, the hollow pieces 121 may also only comprise the first branch, or the hollow pieces 121 includes the first branch and the second branch, wherein the first branch is not vertical to the second branch, and an angle between the first branch and the second branch could be any angle greater than 0.

Continuously referring to FIG. 4, the light shield layer 13 includes a first light shield portion 131 and a second light shield portion 132. In the thickness direction of the bendable device 1, the supporting layer 12 is bonded with one side of the flexible layer 11 by a pressure-sensitive adhesive 17, and the first light shield portion 131 is bonded to a side of the supporting layer 12 away from the flexible layer 11 by another pressure-sensitive adhesive 17 avoiding the hollow pieces 121. The second light shield portion 132 is bonded with one side of the first light shield portion 131 away from the flexible layer 11 by still another pressure-sensitive adhesive 17.

In the present embodiment, the flexible screen 11, the supporting layer 12, the first light shield portion 131 and the second light shield portion 132 are bonded by the pressure-sensitive adhesives 17. It could be understood that, in other embodiments, the flexible layer 11, the supporting layer 12, the first light shield portion 131 and the second light shield portion 132 may also be bonded by adhesive glue or other glues.

Meanwhile, referring to FIGS. 4 and 6, the bendable device 1 further includes a first buffer layer 15 and a second buffer layer 16, wherein the buffer layer 15 and the second buffer layer 16 are respectively made of glue material. The first buffer layer 15 is arranged between the hollow pieces 121 and the flexible layer 11, and the second buffer layer 16 is arranged between the hollow pieces 121 and the first light shield portion 131. Specifically, a first groove 121c is formed at one side of the hollow pieces 121 close to the flexible layer 11, and filled by the first buffer layer 15, so that the external surfaces of the first buffer layer 15 and the supporting layer 12 close to one side of the flexible screen 11 are substantially flush. A second groove 121d is formed at one side of the hollow pieces 121 close to the first light shield portion 131, and filled by the second buffer layer 16, so that the external surfaces of the second buffer layer 16 and the supporting layer 12 away from the flexible screen 11 are substantially flush.

According to the present disclosure, two buffer layers are attached to upper and lower surfaces of the hollow pieces 121 of the supporting layer 12 respectively, and the flexible layer 11 could be supported and protected by the first buffer layer 15 and the second buffer layer 16. Meanwhile, the first buffer layer 15 and the second buffer layer 16 are made of glue materials which could absorb the stress, therefore, the stress of the hollow supporting layer, especially the horizontal stress, could be relieved by providing the first buffer layer 15 and the second buffer layer 16, and meanwhile, the bendable device could also be leveled through the first buffer layer 15 and the second buffer layer 16.

Further, when the bendable device is bent, the modulus transition at the hollow portion and the non-hollow portion in the hollow pieces 121 differs considerably. The bendable device 1 easily has a small R angle in the bending area when bending, and when the bendable device 1 is bent, the edge of the hollow portion of the hollow pieces 121 would rub and damage the flexible screen 11. In the present disclosure, buffer materials are filled at upper and lower sides of the hollow pieces 121 respectively, which could prevent that the bendable device 1 has too small R angle in the bending area when bending and prevent burr at the edge of the hollow portion in the hollow pieces 121 from damaging the flexible screen 11.

In the present embodiment, the flexible layer 11 could be a flexible display or a flexible sensor, and is configured to display images or input a touch signal. The supporting layer 12 could be made of stainless steel sheets, and is configured to provide a supporting role for the flexible layer 11. The first light shield portion 131 could be made of copper foil materials, and is configured to remove heat and improve visual effect of the bendable device 1. The second light shield layer 131 could be made of black mylar materials, and is configured to improve the visual effect of the bendable device 1. The first buffer layer 14 could be made of at least one of polyimide (PI), polyethylene terephthalate (PET), polyurethane (PU) materials, and glue materials; and the second buffer layer 16 may also be made of at least one of polyimide (PI), polyethylene terephthalate (PET), polyurethane (PU) materials, and glue materials.

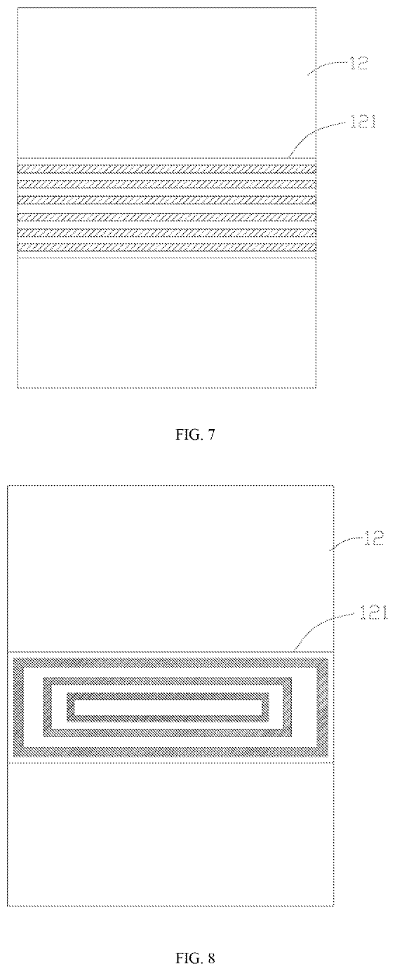

Based on the above-mentioned embodiment, the present disclosure further discloses a second specific embodiment. Referring to FIG. 7, the present embodiment has a distinction from the above-mentioned embodiment in that, in the present embodiment, the hollow pieces 121 only includes the first branch 121a which includes the strip.

Based on the above-mentioned embodiment, the present disclosure further discloses a third specific embodiment. Referring to FIG. 8, the present embodiment has a distinction from the above-mentioned embodiment in that, in the present embodiment, the hollow pieces 121 is of the a plurality of surrounding rectangles.

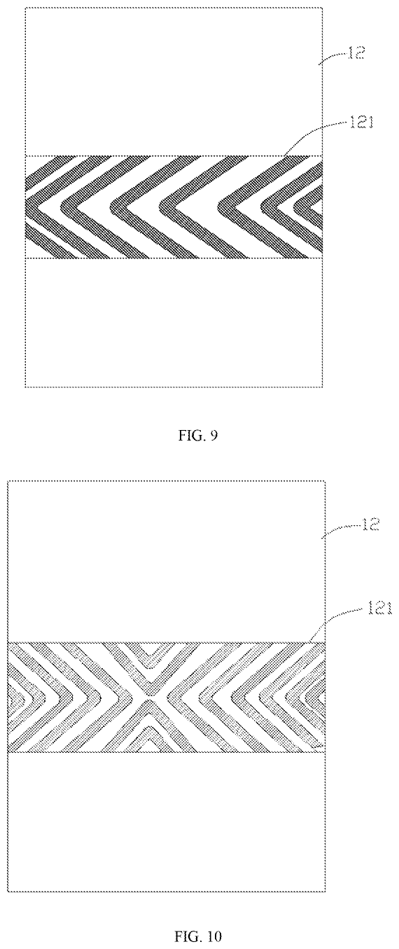

Based on the above-mentioned embodiment, the present disclosure further discloses a fourth and a fifth specific embodiment. Referring to FIGS. 9 and 10, the present embodiment has a distinction from the above embodiment in that, in the present embodiment, the hollow pieces 121 is of a V-shaped structure.

It could be understood that the structure of the hollow pieces 121 is not limited to the labyrinth structure, the surrounding rectangles structure and the V-shaped structure of the above-mentioned embodiment, and may also be any two or more combinations of the above structures, or other structures.

The above embodiments are only better specific embodiments of the present disclosure, but the protection scope of the present disclosure is not limited to this. Changes or replacements which could be easily thought of by those skilled in the art in the technical scope disclosed by the present disclosure should be fallen within the protection scope of the present disclosure. Therefore, the protection scope of the present invention should be subject to the protection scope of claims.

1. A bendable device, comprising:
a flexible layer;
a supporting layer; and
a bending layer, comprising a first main body, a second main body and a bendable component, wherein the first main body is connected with the second main body through the bending component;
the bending layer, the supporting layer and the flexible layer are arranged in a laminated manner successively, the supporting layer comprises a hollow pieces corresponding to the bendable component, and the hollow pieces comprises at least one first branch with a vertical component.

2. The bendable device according to claim 1, wherein the hollow pieces further comprises at least one second branch with a horizontal component.

3. The bendable device according to claim 1, wherein the bendable device further comprises a first buffer layer arranged between the hollow pieces and the flexible layer.

4. The bendable device according to claim 3, wherein a first groove is formed at one side of the hollow pieces close to the flexible layer, and filled by the first buffer layer.

5. The bendable device according to claim 1, wherein the bendable device further comprises a second buffer layer arranged between the hollow pieces and the bendable component.

6. The bendable device according to claim 5, wherein a second groove is formed at one side of the hollow pieces close to the bendable component, and filled by the second buffer layer.

7. The bendable device according to claim 1, wherein the first branch comprises a strip.

8. The bendable device according to claim 1, wherein the hollow pieces is one or any combination of a labyrinth structure, a structure having a plurality of rectangles surrounding one by one, and a V-shaped structure.

9. The bendable device according to claim 3, wherein the first buffer layer is made of at least one of polyimide, polyethylene terephthalate, polyurethane, and glue materials.

10. The bendable device according to claim 5, wherein the second buffer layer is made of at least one of polyimide, polyethylene terephthalate, polyurethane, and glue materials.
